(19) United States
(12) Patent Application Publication
(10) Pub. No.: US 2014/0146393 A1
(43) Pub. Date: May 29, 2014

(54) TRANSMITTED LIGHT CONTROL DEVICE

(71) Applicant: NIGATA UNIVERSITY, Niigaata (JP)

(72) Inventors: Akira Baba, Niigata (JP); Rapiphun Janmanee, Niigata (JP); Koji Tada, Niigata (JP); Kazunari Shinbo, Niigata (JP); Keizo Kato, Niigata (JP); Futao Kaneko, Niigata (JP)

(73) Assignee: NIIGATA UNIVESITY, Niigata (JP)

(21) Appl. No.: 14/100,722

(22) PCT Filed: Jun. 11, 2012
(86) PCT No.: PCT/JP2012/064867

§ 371 Date: Feb. 10, 2014

(30) Foreign Application Priority Data
Jun. 13, 2011 (JP) 2011-131702

(51) Int. Cl. G02B 5/18

(52) U.S. Cl. CPC G02B 5/1866
USPC 359/569

(57) ABSTRACT

There is provided is a transmitted light control device capable of controlling a peak wavelength and a peak intensity of transmitted light while keeping a sharp wavelength width.

A transmitted light control device 10 includes: a grating substrate 1; a metal thin film 2; a conducting polymer layer 3 made by depositing a conducting polymer on the metal thin film 2; a cell 4 filled with a liquid medium 5 composed of an electrolyte or a buffer solution and configured such that a part of the liquid medium 5 is in contact with the conducting polymer layer 3; and a metal thin film potential control means 6 having a working electrode W connected to the metal thin film 2 and having a counter electrode C and a reference electrode R each connected to the liquid medium 5. The substrate 1 and at least a part of the cell 4 are made of a light transmitting material. The control means 6 changes a potential of the metal thin film 2 to thereby change a complex dielectric constant of the conducting polymer layer 3, thereby controlling light transmitted through the conducting polymer layer 3.

### TECHNICAL FIELD

The present invention relates to a transmitted light control device capable of controlling the wavelength and the intensity of transmitted light by utilizing a surface plasmon resonance extraordinary transmission phenomenon.

### BACKGROUND ART

There is a control device utilizing metal nanoparticles known as a conventional wavelength control device controlling the wavelength of transmitted light. As the control device utilizing metal nanoparticles, a polarization control element, in which a plurality of metal microstructures are spatially asymmetrically arranged and which is capable of modulating the polarization state of incident light by an external voltage, is disclosed, for example, in Patent Document 1 (see FIG. 13 in the document). The polarization control element disclosed in Patent Document 1 has a wavelength dependency because it utilizes resonance of plasmons in metal, and the operating wavelength of the polarization control element can be controlled by the material and size of the metal microstructures, the dimension of a dielectric thin film, the distance between the metal microstructures by application of voltage or the like (see the description in paragraphs 0080 and 0095 in the document).

However, since the control device disclosed in Patent Document 1 utilizes the normal surface plasmon resonance excited in the metal nanoparticles (see FIG. 7 of the document), the wavelength width (half value width (FWHM; Full Width Half Maximum)) of the transmitted light obtained after the control is generally wide, so that it is difficult to control the transmitted light so as to have a specific peak wavelength having a very narrow half value width and to take it out.

Further, since the control of the above-described operating wavelength requires the change in the distance between the metal microstructures by the application of the external voltage or the change of the material and size of the metal microstructures (or the dielectric thin film) itself, it is predicted to be difficult to prominently and freely adjust the peak wavelength and the intensity of the transmitted light once the device is manufactured.

Recently, it is further reported that a phenomenon, that when light is irradiated on a nanohole array made of metal, the surface plasmons resonate in the incident light under a certain condition and the surface plasmons do not locally exist on the surface but are transmitted to the opposite side with a sharp peak (a phenomenon that an extraordinary transmission peak appears in a transmission spectrum), is observed (see Non-Patent Document 1). Further, when white light is irradiated, the wavelength of the extraordinary transmitted light can be changed by changing the size of the nanohole. For this reason, the phenomenon of the extraordinary transmitted light is considered to be applicable to a color filter, a high-sensitive sensor capable achieving a small SN ratio as compared with a sensor using a reflected light, a photonic crystal and so on, and is getting more attention (see Non-Patent Document 2).

Note that highly accurate periodic hole arrays made of aluminum in nanoscale are formed and color filters with five colors such as red, orange, yellow, green, blue are suggested in Non-Patent Document 2. However, the technique disclosed in Non-Patent Document 2 utilizes the extraordinary transmission phenomenon of light due to the surface plasmon resonance, and therefore can take out specific light excellent in monochromaticity and transmittance, but does not provide a control device capable of shifting the peak wavelength of transmitted light or increasing and decreasing its wavelength intensity once the hole arrays are formed on a glass substrate.

### PRIOR ART DOCUMENT

### Patent Document

Patent Document 1: Japanese Patent No. 4589804

### Non-Patent Document

Non-Patent Document 1: T. W. Ebbesen et al.: Nature., Vol. 391, pp. 667-669, 1998.
Non-Patent Document 2: IKEDA Naoki and three others, “Success in the Development of Full Color Filter using Surface Plasmon-Nano-Photonic Devices Nano Processing Technology produces-” [online], Mar. 26, 2009, National Institute of Materials Science, [retrieved on Jun. 8, 2011], Internet
   <URL: http://www.nims.go.jp/news/press/2009/03/200903260/p200903260.pdf>

### DISCLOSURE OF THE INVENTION

### Problems to Be Solved by the Invention

The present invention has been made in consideration of the above circumstances and an object thereof is to provide a transmitted light control device with a simple structure, capable of controlling transmitted light. More particularly, the object is to provide a transmitted light control device capable of shifting a peak wavelength and increasing and decreasing its intensity while keeping the transmitted light in a sharp wavelength width (with a narrow half value width).

Another object of the present invention is to provide a transmitted light control device capable of actively and reversibly shifting the peak wavelength of the transmitted light and increasing and decreasing its intensity even after the device is once fabricated.

Still another object of the present invention is to provide a compact and high-sensitive biosensor utilizing transmitted light.

After earnest study, the present inventors found that the surface plasmon resonance extraordinary transmitted light as in the case of transmission through the nanohole arrays is observed even by using a substrate in which a metal thin film is deposited on a grating substrate. In addition, the present inventors fabricated a device in which a conducting polymer was further deposited on the grating substrate/metal thin film, and found that electrochemical control of the potential of the metal thin film changes the complex dielectric constant of the conducting polymer to make it possible to efficiently control the wavelength of light transmitted through the conducting polymer (preferably, extraordinary transmitted light), thus finally coming to completion of the present invention.

### Means for Solving the Problems

More specifically, the present invention has, for example, the following configuration and characteristics.

(Aspect 1) A transmitted light control device including:

a grating substrate having a surface, on which microstructures are periodically formed;

a metal thin film deposited on the substrate;

a conducting polymer layer made by depositing a conducting polymer on the metal thin film;

a cell filled with a liquid medium composed of an electrolyte or a buffer solution and configured such that a part of the liquid medium is in contact with the conducting polymer layer; and

a metal thin film potential control means having a working electrode connected to the metal thin film and having a counter electrode and a reference electrode each connected to the liquid medium,

wherein the substrate and at least a part of the cell are made of a light transmitting material, and

wherein the control means changes a potential of the metal thin film to thereby change a complex dielectric constant of the conducting polymer layer, thereby controlling light transmitted through the conducting polymer layer.

(Aspect 2) The transmitted light control device according to aspect 1,

wherein the part of the cell is provided with a light receiving part that receives incident light, the light is irradiated on the light receiving part and then transmitted through the liquid medium, the conducting polymer layer, and the metal thin film, and then is emitted from the substrate to an outside of the device.

(Aspect 3) The transmitted light control device according to aspect 1 or 2,

wherein the microstructures form groove shapes and are periodically formed at a pitch of 300 nm to 1.6 μm.

(Aspect 4) The transmitted light control device according to any one of aspects 1 to 3,

wherein at least one or more additional layers made by depositing a conducting polymer of a different kind from the conducting polymer are formed on the conducting polymer layer.

(Aspect 5) The transmitted light control device according to any one of aspects 1 to 4,

wherein the conducting polymer includes at least one of polyaniline and poly(3,4-ethylenedioxythiophene).

(Aspect 6) The transmitted light control device according to aspect 5,

wherein the conducting polymer layer has a thickness of 10 nm to 40 nm.

(Aspect 7) A biosensor including:

a grating substrate having microstructures periodically formed on a surface;

a metal thin film deposited on the substrate;

a conducting polymer layer made by depositing a conducting polymer on the metal thin film;

a cell filled with a liquid medium composed of an electrolyte or a buffer solution and configured such that a part of the liquid medium is in contact with the conducting polymer layer; and

a metal thin film potential control means having a working electrode connected to the metal thin film and having a counter electrode and a reference electrode each connected to the liquid medium,

wherein the substrate and at least a part of the cell are made of a light transmitting material,

wherein an inspection object is injectable into the liquid medium,

wherein the control means changes a potential of the metal thin film to thereby change a complex dielectric constant of the conducting polymer layer, thereby controlling light transmitted through the conducting polymer layer, and

wherein presence or absence and a concentration of the inspection object in the liquid medium are detectable from a change in transmitted light state.

### Effect of the Invention

The transmitted light control device of the present invention can control transmitted light by the above-described simple configuration. More specifically, this device includes the conducting polymer layer that changes in complex dielectric constant due to change in external potential and a diffraction grating (grating structure) in a predetermined size, and therefore can freely and reversibly change the extraordinary transmission state of surface plasmon resonance of the transmitted light. This makes it possible to shift the peak wavelength and increase and decrease its intensity (namely, switching of the transmitted light) while keeping the transmitted light in a sharp wavelength width (with a narrow half value width).

Note that according to later-described examples, the device of the present invention is capable of shifting the peak wavelength by up to 250 nm and thus increasing and decreasing the peak intensity in a range of 1 time to 6 times. Except the device of the present invention, any transmitted light control device capable of modulating the shift amount and the intensity in such large ranges is not found at present.

Further, since the metal thin film potential control means can freely and reversibly change the potential of the metal thin film, the transmitted light control device of the present invention can be used over and over again without replacing the substrate serving as the optical diffraction grating and the thin film layer thereon or changing them with ones having other dimensions.

Further, application of the technical scope of the present invention makes it possible to realize a color filter capable of modulating color (namely, an active plasmonic nanofilter), a highly efficient solar cell, and a biosensor as well as the above-described transmitted light control device. Note that the biosensor of the present invention has the configuration utilizing the transmitted light as described above and is therefore expected to be a compact portable high-sensitive sensor. Further, the present invention is not limited to the exemplified examples, a polarizer and a photonic crystal can also be realized by applying the present invention.

### BRIEF DESCRIPTION OF DRAWINGS

FIG. 1 A view schematically illustrating a transmitted light control device of the present invention.

FIG. 2 A simulation result illustrating the relation between the change in complex dielectric constant of a conducting polymer layer and the intensity of transmitted light.

FIG. 3 A graph illustrating the relation between the change in potential of a metal thin film and the intensity of surface plasmon resonance extraordinary transmitted light (Example 1).

FIG. 4 A graph illustrating the relation between the change in potential of a metal thin film and the intensity of surface plasmon resonance extraordinary transmitted light (Example 2).

FIG. 5 A graph illustrating the relation between the change in potential of a metal thin film and the intensity of surface plasmon resonance extraordinary transmitted light (Example 3).

FIG. 6 A graph illustrating the relation between the change in potential of a metal thin film and the intensity of surface plasmon resonance extraordinary transmitted light (Example 4).

FIG. 7 Graphs illustrating the intensity characteristics of surface plasmon resonance extraordinary transmitted light in a biosensor being a modified example of the present invention (Example 5).

### BEST MODE FOR CARRYING OUT THE INVENTION

Hereinafter, the present invention will be described on the basis of an embodiment illustrated in the drawings, but the present invention is not limited at all to the following concrete embodiment.

(Outline of Transmitted Light Control Device)

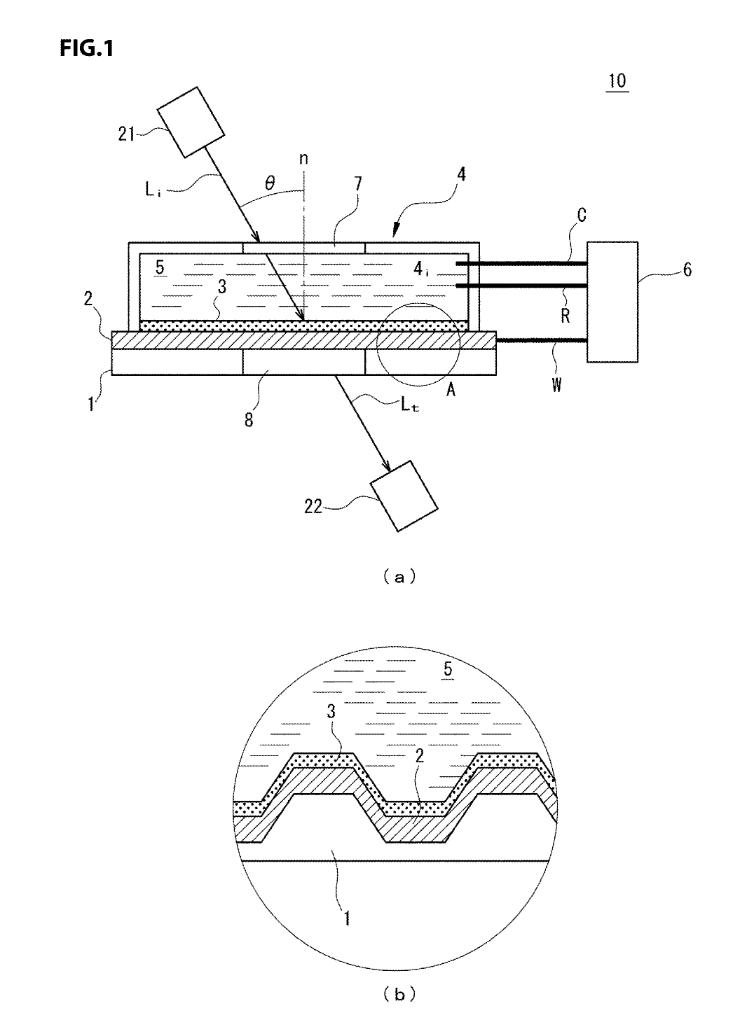

FIG. 1(a) is a view illustrating an outline of a transmitted light control device 10 of the present invention. Note that FIG. 1(a) partially illustrates a state of a cross-section for easy viewing of the internal structure of the transmitted light control device 10. FIG. 1(b) is an enlarged view of a portion of a circle A in FIG. 1(a). As illustrated in FIG. 1(a), the transmitted light control device 10 (hereinafter, referred to simply as a “device”) includes a grating substrate 1, a metal thin film 2 made by depositing metal on the substrate 1, and a conducting polymer layer 3 made by depositing a conducting polymer on the metal thin film 2. The device 10 further has a container made of a light transmitting material (for example, plastic) that partially (for example, a later-described light receiving part 7) or wholly transmits light (hereinafter, referred to simply as an “electrochemical cell” or a “cell”) 4. The cell 4 has an inner space 4ᵢ filled with a liquid medium 5 composed of electrolyte or buffer solution and is configured such that a part of the liquid medium 5 is in contact with the conducting polymer layer 3. The device 10 further has a metal thin film potential control means 6 (hereinafter, referred to simply as a “potential control means” or a “control means”) having a working electrode W connected to the metal thin film 2 and having a counter electrode C and a reference electrode R each connected to the liquid medium 5.

The transmitted light control device 10 of the present invention having the above configuration is characterized in that the control means 6 is used to change a potential of the metal thin film 2 using the reference electrode R as a reference and thereby change a complex dielectric constant of the conducting polymer layer 3 and an extraordinary transmission state of surface plasmon resonance of light passing through the conducting polymer layer 3, so as to control the peak wavelength of the transmitted light emitted from the device 10 and the light intensity of the peak wavelength (hereinafter, also referred to as a “peak intensity”).

(Electrolyte)

Examples of the electrolyte usable as the liquid medium 5 include water-soluble chemical compounds (solutes) such as sodium chloride, hydrogen chloride, copper chloride, sodium hydroxide, sulfate and the like. When these compounds are dissolved in water, the resulting solutions exhibit a property of passing current. The electrolyte 5 may also be a compound (solute) such as tetrabutylammonium hexafluorophosphate, lithium perchlorate or the like, in which case a solution obtained by dissolving the compound in an organic solvent (for example, acetonitrile, tetrahydrofuran (THF)) exhibits a property of passing current.

(Buffer Solution)

Further, a buffer solution may be used as the liquid medium 5. In the case of using the present invention as a biosensor, an inspection object can be injected into the buffer solution 5. Examples usable as the buffer solution 5 include publicly-known buffer solutions such as a phosphate buffer solution, a citrate buffer solution, a tris buffer solution and the like, but are not always limited to them.

(Grating Substrate)

The grating substrate 1 here means a substrate that is formed of a light transmitting material, for example, glass or plastic (preferably, polycarbonate) and has microstructures, serving as optical diffraction gratings, periodically formed on a surface thereof, and has a structure in which, for example, many grooves, linearly extending on one surface thereof and each having an almost rectangular cross-section, are periodically provided at intervals (pitches) of 300 nm to 1.6 μm in the horizontal direction of the surface. Note that though light is transmitted through the substrate 1 even if the thickness of the substrate 1 is large, the substrate 1 desirably has a thickness of 100 μm to 2 mm for practical purpose in terms of appropriately holding the plurality of later-described thin film layers 2, 3 to be deposited on the substrate 1 and fixing on the cell 4. Note that the periodic microstructures for imparting the gratings may be configured such that grooves each having a rectangular cross-section are arranged side by side at regular intervals, or may have a projecting and recessed pattern without angled portions or corner portions of rectangular cross-sections, as illustrated in FIG. 1(b) or otherwise a cross-sectional profile drawing a sine wave curve.

The metal thin film 2 and the conducting polymer layer 3, which are deposited on the substrate 1, constitute the structure corresponding to the gratings (microstructures) on the substrate 1 in the example illustrated in FIG. 1(b). A structure constituting the plurality of layers 1 to 3 forms a diffraction grating structure in which gratings, through which only light Lₜ with a certain wavelength can pass when light Lᵢ illustrated by an arrow in FIG. 1(a) is irradiated, are periodically arranged at the above-described groove intervals.

Examples of the material of the metal thin film 2 include metals which are likely to cause surface plasmon resonance by reflecting the grating structure on the substrate 1, for example, noble metals such as gold, silver, aluminum and the like, and gold that is a material less likely to oxidize is more preferable because the electrochemical cell 4 filled with the liquid medium 5 such as electrolyte or the like is used in the device 10 of the present invention. Further, the thickness of the metal thin film 2 preferably ranges from 30 nm to 50 nm for the reasons that a transmission-type surface plasmon resonance phenomenon is likely to occur and so on. Note that the metal thin film 2 may be deposited on the substrate 1 using the vacuum deposition method, the sputtering method, the CVD method or the like.

Further, a chromium (Cr) thin film layer (not illustrated) with a thickness of about 1 nm to about 10 nm may be deposited between the metal thin film 2 and the substrate 1. This is because the metal thin film 2 (for example, gold (Au) thin film) is sometimes likely to peel off the substrate 1, and by interposing the chromium (Cr) layer between the substrate 1 and the metal thin film 2, the adhesiveness between them can be improved.

In the present invention, it is important that the conducting polymer layer 3 is further provided on the metal thin film 2. Examples of the conducting polymer forming the layer 3 include polyaniline (abbreviated expression is PANI), Polypyrrole (abbreviated expression is PPy), polythiophene (abbreviated expression is PT) derivative, Poly(3,4-ethylenedioxythiophene) (abbreviated expression is PEDOT), polyacetylene, Poly(p-phenylene) (abbreviated expression is PPP), Poly(p-phenylene vinylene) (abbreviated expression is PPV), or combinations thereof.

The conducting polymer layer 3 containing the above-described compound may be deposited on the metal thin film 2 using a publicly-known manufacturing method, such as the electropolymerization method, the spin coat method, or the alternate adsorption method. For the reasons that precise control of the thickness is easy and that fabrication is possible with a simple apparatus and in a short time, the electropolymerization method is preferable.

Though not illustrated, it is preferable that on the conducting polymer layer 3, at least one or more additional layers (not illustrated), made by depositing a conducting polymer of a different kind from the conducting polymer used for the layer 3, are formed. Provision of the additional layers in the device 10 of the present invention makes it possible to cause, in addition in the wavelength region where the surface plasmon resonance extraordinary transmission due to the existence of the conducting polymer layer 3, an extraordinary transmission phenomenon in another wavelength region due to the existence of the additional layers made of the different polymer. This makes it possible to more freely control the shift amount of the peak wavelength, the increase/decrease amount of the peak intensity and so on, probably resulting in broadened usage and application range of the transmitted light control device 10 of the present invention.

Note that in the case of using polyaniline (PANI) or poly(3,4-ethylenedioxythiophene) (PEDOT) for the conducting polymer layer 3, it is preferable to set the thickness of the polymer layer 3 to about 10 nm to about 40 nm. The thickness of the layer 3 of less than 10 nm is not preferable because the polymer layer 3 cannot sufficiently absorb incident light. On the other hand, the thickness of the polymer layer 3 of larger than 40 nm is not preferable because the polymer layer 3 absorbs incident light Lᵢ too much so that extraordinary transmission of light due to the surface plasmon resonance becomes less likely to occur or a transmitted light detector 22 becomes difficult to sufficiently detect the extraordinary transmitted light Lₜ.

Further, at least a part of a surface of the electrochemical cell 4 constitutes the light receiving part 7 that receives the incident light Lᵢ. The incident light Lᵢ from the light receiving part 7 enters the device 10 after being p-polarized by a not-illustrated polarizer, passes through the liquid medium 5, the conducting polymer layer 3, the metal thin film 2, and the grating substrate 1, and is then emitted to the outside of the device 10. Note that in the example illustrated in FIG. 1, the grating substrate 1 and the metal thin film 2 are not covered with the cell 4 but is configured to be exposed to the outside, in which case a part of the grating substrate 1 constitutes an emitting part 8 that emits the transmitted light Lₜ.

The incident light Lᵢ here may be irradiated obliquely to a surface n vertical to the plane of the substrate 1 as illustrated in FIG. 1, and the angle between the incident plane and the vertical surface n is called an incident angle θ. An electric field of the p-polarized incident light Lᵢ enters the cell 4 while vibrating within the incident plane. Note that the incident light having the electric field vibrating vertically to the incident plane is called an s-polarized light.

In the example illustrated in FIG. 1, the incident light Lᵢ is white light that is radiated from a light irradiator 21 and p-polarized by the not-illustrated polarizer or the like, and is irradiated on the light receiving part 7 while having the angle θ with respect to the surface n vertical to the installation surface of the grating substrate 1 and so on. The incident light Lᵢ is not limited to the white light.

On the other hand, the transmitted light Lₜ transmitted through the components 1 to 4 of the device 10 and emitted from the emitting part 8 is subjected to detection of the wavelength and intensity of the transmitted light Lₜ by the transmitted light detector 22.

The device 10 further includes the potential control means 6 (for example, a potentiostat). The potential control means 6 in this embodiment includes the working electrode W which is connected to the metal thin film 2 and the reference electrode R and the counter electrode C which are connected to the liquid medium (for example, electrolyte) 5. The potential control means 6 having the above configuration can arbitrarily restrict (control) the potential of the metal thin film 2 connected with the working electrode W using the potential of the liquid medium 5 connected to the reference electrode R as a reference.

(Relation Between Change in Complex Dielectric Constant and Intensity of Transmitted Light)

Incidentally, the conducting polymer layer 3 made of polyaniline (PANI) or the like shows two states called a “doped state” and an “dedoped state.” The doped state is a state in which under the setting that the working electrode W connected to the metal thin film 2 has a positive potential, polyaniline lacks an electron and thus has a plus charge with a negative ion (namely, anion) taken therein in order to neutralize the positive charge, and thereby becomes conductive. On the other hand, the dedoped state is a state in which under the setting that the working electrode W has a negative potential, polyaniline has no charge with the negative ion (anion) taken therein in the previous doped state being emitted therefrom into the solution, and thereby becomes insulative. In short, the conducting polymer such as polyaniline or the like reversibly changes in dielectric constant (complex dielectric constant) according to each of the states (doped state and dedoped state) that can be arbitrarily set by the working electrode W. Here, since the conducting polymer is generally accompanied by change in light absorption in the near-ultraviolet region to the near-infrared region depending on the change of the doped state, the term of (optical) complex dielectric constant including also the change in light absorption (namely, extinction coefficient) is used as the dielectric constant.

The change in the reversible state (the reversible state change between the doped state and the dedoped state) in the conducting polymer layer 3 is electrochemically performed in many cases, in which an electron is transferred between a conjugated polymer and a dopant or an electrode and thereby causes transition between metal (conductor) and insulator to change the optical characteristics (for example, complex dielectric constant) of the conducting polymer layer 3. Further, the conducting polymer (in particular, polyaniline (PANI) or poly(3,4-ethylenedioxythiophene) (PEDOT)) has an energy band gap in the visible light region, and changes in characteristics of absorbing the transmitted light Lₜ because the band state changes depending on the above-described reversible state change (the state change between the doped state and the dedoped state). Due to this electrochromism, the optical characteristics greatly change.

The surface plasmon resonance phenomenon excited on the surface of the metal thin film 2 differs in resonance excitation condition due to a very thin film material of several nanometers to several tens of nanometers further existing (deposited) on the surface of the metal thin film 2. Further, since the resonance excitation condition changes with a high sensitivity according to the change in the complex dielectric constant of the film material, it becomes possible to control the surface plasmon resonance excitation condition by controlling the complex dielectric constant of the film material existing on the metal thin film 2. In other words, it becomes possible to control the wavelength and the intensity of the transmitted light Lₜ by controlling the doped state of the conducting polymer thin film (layer) 3 existing on the metal thin film 2.

To investigate the influence of the change in the complex dielectric constant of the conducting polymer layer 3, being one component of the device 10, affecting the intensity of the transmitted light Lₜ transmitted through the device 10, the following simulation was carried out.

A model of the simulation is described, here. As the grating substrate 1, a polycarbonate substrate having grooves with dimensions of a depth of 55.5 nm, a width of 370 nm, and a pitch of 740 nm was assumed. As the metal thin film 2, a gold (Au) thin film with a thickness of about 37 nm was assumed. As the conducting polymer layer 3, a polyaniline thin film with a thickness of about 18.5 nm was assumed. Further, as an input value of the complex dielectric constant in the doped state and the dedoped state of the conducting polymer layer 3, the wavelength dispersion characteristics which were actually measured before by the present inventors (actual measured result of the complex dielectric constant change corresponding to the wavelength range (λ was 480 nm to 800 nm)) were used.

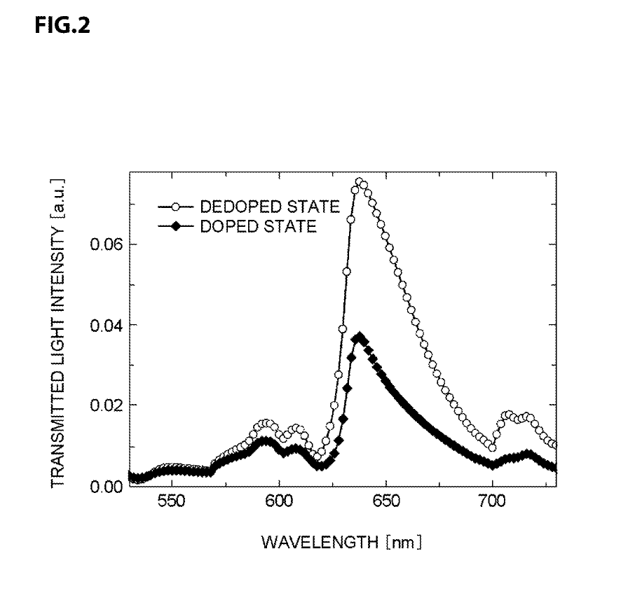

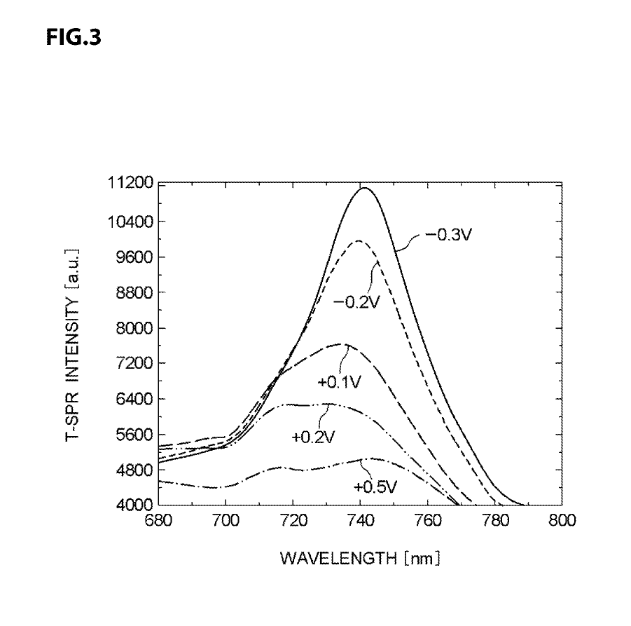

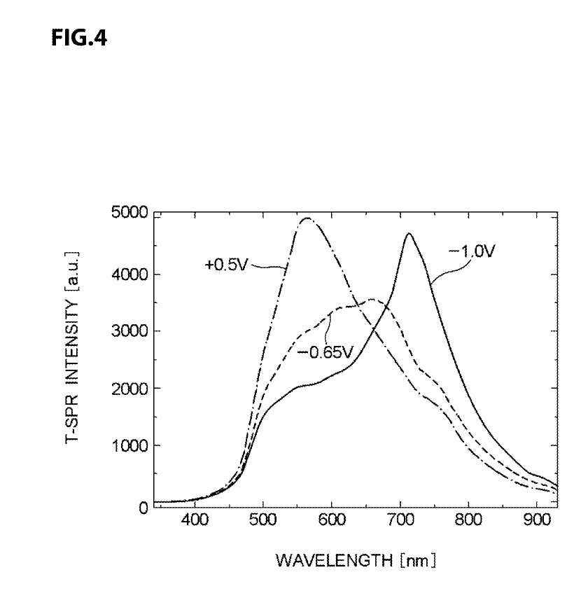

FIG. 2 is a graph illustrating the relation between the change in the complex dielectric constant (the doped state and the dedoped state are assumed) and the intensity of the transmitted light Lₜ when the p-polarized light is irradiated using the model in which the polyaniline layer 3 is deposited on the grating substrate 1/the metal thin film 2 as described above. Here, the horizontal axis in FIG. 2 indicates the wavelength (unit is nm) and the vertical axis indicates the transmitted light intensity (unit is arbitrary, a.u. shown in the graph). Note that the same applies to the horizontal axis and the vertical axis and the notation in later-described FIG. 3 and FIG. 4. As in the simulation result illustrated in FIG. 2, it is found that the intensity of the transmitted light Lₜ greatly changes with the change of the above-described state of the conducting polymer layer 3.

The reason is believed that when the complex dielectric constant of the conducting polymer layer 3 changes, the magnitude of the electric field generated at the interface between the conducting polymer layer 3 and the element adjacent thereto (the electrolyte 5 or the metal thin film 2) also differs due to the transmission-type surface plasmons transmitted through the conducting polymer layer 3.

(Relation Between Change in Potential of Metal Thin Film and Intensity of Surface Plasmon Resonance Extraordinary Transmitted Light)

The device 10 of the present invention was actually fabricated as follows, and the surface plasmon resonance extraordinary transmitted light characteristic (later-described T-SPR intensity) according to the potential of the metal thin film 2 was evaluated using the measurement system as illustrated in FIG. 1.

### Example 1

(Example 1: A Case where the Conducting Polymer is PANI and θ=0°)

In Example 1, a polycarbonate recording medium (DVD-R, manufactured by TAIYO YUDEN Co., Ltd.) having grooves with a depth of about 130 nm, a width of about 370 nm, and a pitch of about 740 nm was used as the grating substrate 1. As the metal thin film 2, a gold (Au) thin film with a thickness of about 50 nm was deposited on the substrate 1 using the vacuum deposition method. As the conducting polymer layer 3, a polyaniline (PANI) thin film with a thickness of about 20 nm was deposited on the gold (Au) thin film using the electropolymerization method (Example 1). Note that it is necessary to perform repeatedly all of the steps in the electropolymerization method in order to form a desired thickness, and about 10 cycles were needed for formation of the thickness of about 20 nm in this example.

While the working electrode W was connected to the metal thin film 2 configured as described above, the potentiostat 6 having the reference electrode R and the counter electrode C, each connected to the electrolyte 5, was operated to change the potential of the metal thin film 2 using the potential of the electrolyte 5 as a reference, and the intensities of the transmitted light at different potentials were measured.

Note that in Example 1 and later-described subsequent examples, the incident angle θ of the incident light Lᵢ radiated from the light irradiator 21 toward the device 10 of the present invention was set to 0°. Further, for investigation of the measurement result of the transmitted light intensity, the intensity, measured when the s-polarized light not exciting the surface plasmons was irradiated, was defined as the baseline intensity, and an intensity, obtained by subtracting the baseline intensity from the actually measured intensity (namely, when using the p-polarized incident light), was defined as the surface plasmon resonance extraordinary transmitted light intensity (hereinafter, referred to simply as a “T-SPR intensity”). In Example 1 and subsequent examples, behaviors and tendencies of the peak and the intensity of the transmitted light Lₜ were analyzed and investigated using the T-SPR intensity.

FIG. 3 is a graph illustrating the results of measurement of the intensities of the surface plasmon resonance extraordinary transmitted light under the condition, that the metal thin film 2 was kept constant at various potentials as described above. It is found that the potential of the metal thin film 2 is set in a predetermined range (for example, a range of −0.2 V to −0.3 V), transmitted light Lₜ having a T-SPR intensity (vertical axis) of about 10000 to about 11200 arbitrary unit in a narrow wavelength region (horizontal axis) of approximately 740 nm, namely, a sharp peak is obtained in Example 1 as illustrated in FIG. 3.

It was also confirmed that with the change (for example, a change from +0.5 V to −0.3 V) in the potential of the metal thin film 2, the peak of the T-SPR intensity can greatly change (for example, the peak intensity changes from about 4500 arbitrary unit to about 11200 arbitrary unit). In other words, the device 10 of the present invention can practically select (switch) whether or not (ON/OFF) to emit the transmitted light Lₜ having a high peak. Further, it is found from the result in FIG. 3 that the peak wavelength can be changed, though it is little (for example, though the peak wavelength at +0.1 V is about 735 nm, the peak wavelength at −0.3 V is about 745 nm)

### Example 2

(Example 2: A Case where the Conducting Polymer is PEDOT and θ=0°)

In Example 2, a thiolene substrate in which groove structures of grooves with a depth of about 100 nm, a width of about 370 nm, and a pitch of about 740 nm were periodically arranged was prepared as the grating substrate 1. Concretely, an ultraviolet cure adhesive (thiolene material) was dripped on the recording medium (DVD-R, manufactured by TAIYO YUDEN Co., Ltd.) having the periodic groove structures as described in Example 1. The adhesive was covered with a glass plate from above and irradiated with ultraviolet rays. After the irradiation and thus curing of the adhesive, the DVD-R was peeled off the plate-like thiolene to which the periodic groove shapes of the DVD-R were transferred to thereby fabricate the substrate 1. In Example 2, poly(3,4-ethylenedioxythiophene) (PEDOT) was used as the conducting polymer, and an organic solvent was used together with PEDOT. Since the polycarbonate substrate as the DVD-R used in Example 1 dissolves in the organic solvent, the thiolene substrate not dissolving in the organic solvent was fabricated by the transfer technique in Example 2.

As the metal thin film 2, a gold (Au) thin film with a thickness of about 50 nm and a chromium (Cr) thin film with a thickness of about 10 nm, were deposited on the substrate 1 using the vacuum deposition method. As the conducting polymer layer 3, a poly(3,4-ethylenedioxythiophene) (PEDOT) thin film with a thickness of about 20 nm was deposited on the metal thin film 2 using the electropolymerization method (Example 2). While the working electrode W was connected to the metal (Au/Cr) thin film 2, the potentiostat 6 having the reference electrode R and the counter electrode C connected to the electrolyte 5, was operated to change the potential of the metal thin film 2 using the potential of the electrolyte 5 as a reference, and the T-SPR intensities at different potentials were measured. Note that the control of the potentials and the measurement system were the same as those in Example 1, and the incident angle θ of the incident light Lᵢ was set also to 0°.

FIG. 4 is a graph illustrating the relation between the wavelength and the T-SPR intensity of the transmitted light in the case of using the transmitted light control device 10 according to Example 2. As illustrated in FIG. 4, it was confirmed that the peak wavelength of the transmitted light reversibly greatly shifted from near 560 nm to near 710 nm by changing the potential of the working electrode W (metal thin film 2), in other words, by changing the complex dielectric constant of the conducting polymer layer (PEDOT thin film) 3. It was also observed that in the process of changing the PEDOT thin film 3 between the doped state and the dedoped state, the T-SPR intensity of the peak wavelength was decreased from about 5000 arbitrary unit to about 3000 arbitrary unit. Thus, it was confirmed that changing the potential of the metal thin film 2 makes it possible not only to shift the peak wavelength of the light transmitted through the device 10, but also to increase and decrease the light intensity of the peak wavelength.

### Example 3

(Example 3: A Case where the Conducting Polymer is PEDOT and θ=25°)

In Example 3, in order to grasp the influence of the incident angle θ of the incident light Lᵢ radiated from the light irradiator 21 toward the device 10 of the present invention, the incident angle θ was set to 25°. The measurement system and device structure other than this point were the same as those in Example 2, and the description thereof will be omitted here.

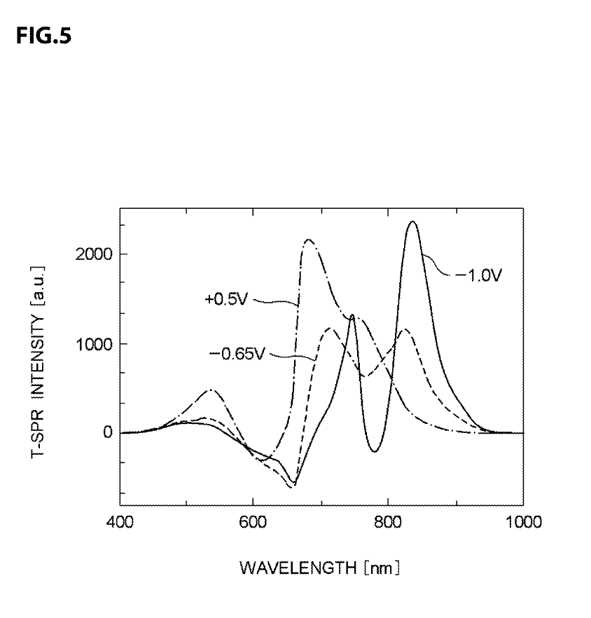

FIG. 5 illustrates the relation between the wavelength and the T-SPR intensity of the transmitted light Lₜ in the case of using the transmitted light control device 10 according to Example 3. As illustrates in FIG. 5, it was confirmed that the peak wavelength of the transmitted light shifted as in Example 2, by changing the potential of the working electrode W (metal thin film 2), in other words, by changing the complex dielectric constant of the PEDOT thin film 3. In particular, in Example 3, it is interesting that, though one peak wavelength was observed near 680 nm at a potential of +0.5 V being the doped state, peak wavelengths with different intensities were observed near 750 nm and near 830 nm respectively at a potential of −1.0 V being the dedoped state.

Further, comparison between the case where the potential is +0.5 V in Example 2 (see FIG. 4) and the case where the potential is −1.0 V in Example 3 (see FIG. 5) shows that the peak wavelength changed from about 560 nm to about 830 nm and the shift amount of the peak wavelength exceeded 250 nm. Note that in both cases of Example 2 and Example 3, the used device 10 and measurement system were the same as described above, but the incident angle θ was merely changed. Accordingly, it is significant that such a great shift amount of the peak wavelength can be obtained only by arbitrarily changing the potential of the metal thin film 2 and the incident angle θ even after the device 10 is once fabricated.

(Cycle Test)

Further, for the devices 10 in the above-described Examples 1 to 3, three cycles of operation, regarding an operation of changing the potential of the metal thin film 2 from +0.5 to −1.0 V and then returning the potential back to the original +0.5 as one cycle, were performed and the transmitted light intensity during each cycle was observed. As a result, similar intensity is results were indicated in any cycles. This proves that the device 10 of the present invention can cause the conducting polymer 3 to exhibit the doped state and the dedoped state at the same level every time, by repeatedly changing the potential of the metal thin film 2 and thereby can realize the reversible change of the transmitted light intensity.

### Example 4

(Example 4: A Case where the Conducting Polymer is PANI and its Thickness is Large)

The control device 10 in Example 4 is described, here. A polycarbonate recording medium (BD-R, manufactured by TAIYO YUDEN Co., Ltd.), having grooves with a depth of about 40 nm and a pitch of about 320 nm, was used as the grating substrate 1 in Example 4. As the metal thin film 2, a gold (Au) thin film with a thickness of about 50 nm was deposited on the substrate 1 using the same manufacturing method as that in Example 1.

In Example 4, PANI was used as the conducting polymer as in Example 1, but it should be noted that its thickness was made larger than that in Example 1. Concretely, the step of the electropolymerization method was carried out 28 cycles to form a conducting polymer layer 3 with a thickness (about 60 nm) about three times that in Example 1.

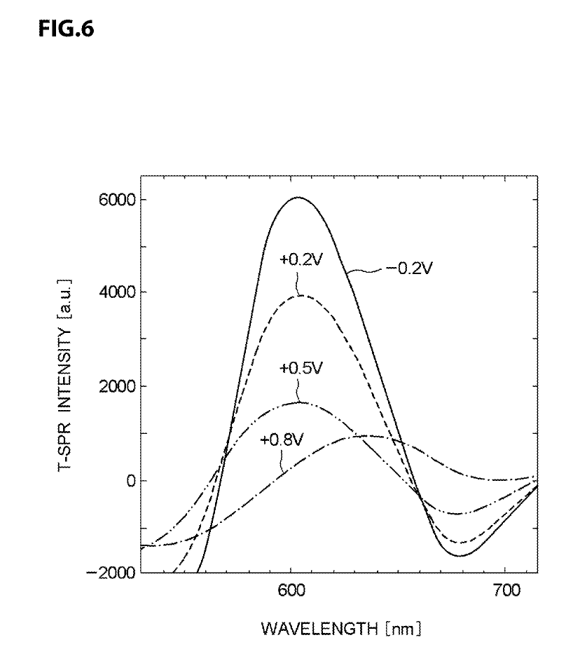

FIG. 6 illustrates the relation between the wavelength and the T-SPR intensity of the transmitted light in the case of using the transmitted light control device 10 according to Example 4. From FIG. 6, the gradual shift of the peak wavelength and the increase/decrease in the peak intensity according to the change in the potential of the metal thin film 2 can be observed. In particular, it is found that the increase/decrease in the T-SPR intensity changes by up to about 6 times (more specifically, changes from about 1000 arbitrary unit to about 6000 arbitrary unit when the potential is changed from 0.8 V to −0.2 V). Thus, it can be said that if the conducting polymer layer 3 is formed with a desired thickness before the device 10 is fabricated, the transmitted light control device 10 capable of prominently changing the peak intensity of the transmitted light Lₜ can be provided.

### Example 5

(Example 5: Application to a Biosensor)

Next, Example 5, in which the technical scope of the present invention is applied to a biosensor 10, is described. The biosensor 10 in Example 5 basically has almost the same structure as that illustrated in FIG. 1, however is characterized in that a buffer solution, in place of the electrolyte used in Examples 1 to 3, is used as the liquid medium 5 adjacent to the conducting polymer layer 3 and that an object to be detected (not illustrated) is injected into the buffer solution. Note that the incident angle θ was set to 60°.

Here, a concrete example is described which uses a PEDOT thin film, a phosphate buffer solution, and ascorbic acid were used as the conducting polymer layer 3, the buffer solution 5 and the object to be detected, respectively.

The detection principle of the biosensor 10 is described first. The transmitted light intensity profiles in the doped state and the dedoped state are grasped under the condition that the ascorbic acid being an analyte has not yet been injected into the buffer solution 5. More specifically, the anions in the conducting polymer layer 3 stay in the layer 3 in the doped state, whereas the anions are likely to move from the conducting polymer layer 3 into the buffer solution 5 in the dedoped state. Thus, the transmitted light intensity profiles in the respective states are generally different.

Next, a case where the ascorbic acid is injected into the buffer solution 5 is assumed. The ascorbic acid injected into the buffer solution 5 does serve as the anion (negatively-charged ion). Accordingly, even if the conducting polymer layer 3 is set to the dedoped state, the behavior of the sensor 10 is different from that under the condition that the analyte is not injected. More specifically, the ascorbic acid (namely, anion) exists in the buffer solution 5, so that as the amount of the existing ascorbic acid is larger, more anions stay in the conducting polymer layer 3. Therefore, it is expected that the transmitted light intensity profile in the dedoped state under the condition that the analyte is injected, indicates an intensity profile close to the transmitted light Lₜ in the doped state, as compared to the profile under the condition that the analyte is not injected.

Note that if the conducting polymer layer 3 is brought into the doped state after the ascorbic acid is injected into the buffer solution 5, the conducting polymer layer 3 is considered to be not so different from that in the doped state under the condition that the ascorbic acid is not injected because the donor in the conducting polymer layer 3 has already been sufficiently anion-doped and the degree of contribution of the ascorbic acid is low. Accordingly, the intensity profile of the transmitted light Lₜ is considered not to greatly change regardless of whether the analyte is injected or not.

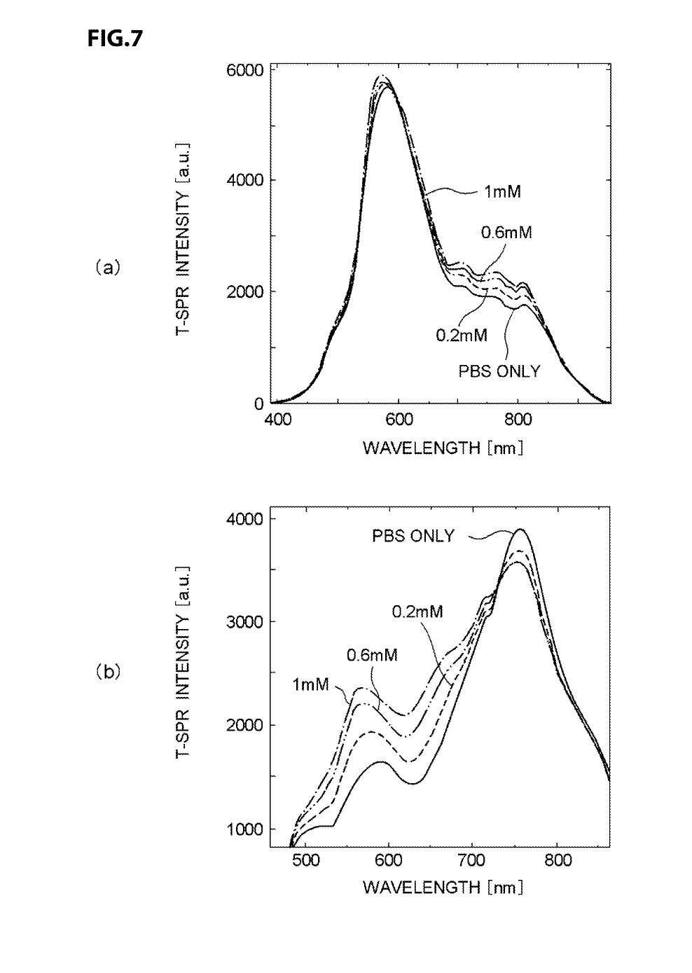

The biosensor 10 in Example 5 was actually fabricated and the test for verifying the measurement performance of the biosensor 10 was carried out. FIG. 7(a) illustrates the T-SPR intensity in the sensor 10 in the doped state. To bring the conducting polymer layer 3 into the above-described doped state, the potential of the metal thin film 2 was set to +0.3 V. FIG. 7(a) concretely illustrates the intensity of the case, where the biosensor 10 was filled only with the buffer solution (see a solid line with “PBS ONLY” in the graph), namely, the condition that the ascorbic acid was not injected, and also the intensities under the conditions that ascorbic acids different in concentration were injected (indicated with 0.2 mM (broken line), 0.6 mM (one-dot chain line) and 1 mM (two-dot chain line) in the graph). It is found, however, that the wavelengths of the peaks are 560 nm under any of the conditions and there is not much difference among the profiles of the intensities.

On the other hand, FIG. 7(b) illustrates the T-SPR intensity of the sensor 10 in the dedoped state. To bring the conducting polymer layer 3 into the above-described doped state, the potential of the metal thin film 2 was set to −1.0 V. Note that the concentration conditions of the ascorbic acid and the notations in the graph are the same as those in FIG. 7(a). As is clear from FIG. 7(b), it was observed that the profiles of the T-SPR intensities under the respective conditions were greatly different. In addition, it was observed that in a wavelength region (near 760 nm), where a high peak was indicated under the condition that the ascorbic acid was not injected (see a solid line with “PBS only” in the graph), as the concentration of the ascorbic acid increased, the light intensity gradually decreased. It was also observed that the intensity increased in the wavelength region (near 560 nm) where the peak was indicated under each condition in the doped state.

From the above results, it was verified that according to the present invention, the high-sensitive biosensor 10, capable of surely detecting not is only presence or absence of an analyte but also the injection concentration of an analyte, can be provided. Further, as described above, the biosensor 10 of the present invention does not require any additional members such as a polarizing plate and so on, which have been necessary for dealing with a reflected light, because of use of the transmitted light Lₜ in place of the reflected light for detection of an analyte, and thus can be reduced in size and cost.

Note that though Example 5 is on the assumption that the analyte is injected into and detected in the buffer solution 5, which stands still in the cell 4, however, a biosensor 10 may be constructed in which, for example, an inlet (not illustrated) into which the buffer solution 5 is introduced may be provided on one side of the cell 4, and an outlet (not illustrated) from which the buffer solution 5 passed through the cell 4 is discharged may be provided on the other side, so that the analyte can dynamically flow inside and outside the cell 4.

### INDUSTRIAL APPLICABILITY

As described above, the device of the present invention enables control of the transmitted light (particularly, the relation between the wavelength and intensity thereof) obtained by utilizing the conducting polymer and the change in complex dielectric constant thereof. The present invention is expected to contribute to application to a variable color filter such as an active plasmonic nanofilter (chrominance modulating color filter) and so on. Further, the present invention is expected to be applied to a sensor such as a portable compact biosensor, an electrochromic display, an energy conversion device, a solar cell and so on as well as the filter.

### EXPLANATION OF CODES

1 grating substrate
2 metal thin film
3 conducting polymer layer
4 cell (electrochemical cell)
5 liquid medium (electrolyte, buffer solution)
6 metal thin film potential control means
7 light receiving part
8 emitting part
10 transmitted light control device, biosensor
C counter electrode
R reference electrode
W working electrode
Lᵢ incident light
Lᵢ transmitted light

1. A transmitted light control device comprising:
a grating substrate having a surface, on which microstructures are periodically formed;
a metal thin film deposited on said substrate;
a conducting polymer layer made by depositing a conducting polymer on said metal thin film;
a cell filled with a liquid medium composed of an electrolyte or a buffer solution and configured such that a part of said liquid medium is in contact with said conducting polymer layer; and
a metal thin film potential control means having a working electrode connected to said metal thin film and having a counter electrode and a reference electrode each connected to said liquid medium,
wherein said substrate and at least a part of said cell are made of a light transmitting material, and
wherein said control means changes a potential of said metal thin film to thereby change a complex dielectric constant of said conducting polymer layer, thereby controlling light transmitted through said conducting polymer layer.

2. The transmitted light control device according to claim 1,
wherein the part of said cell is provided with a light receiving part that receives incident light, the light is irradiated on said light receiving part and then transmitted through said liquid medium, said conducting polymer layer, and said metal thin film, and then is emitted from said substrate to an outside of said device.

3. The transmitted light control device according to claim 1,
wherein the microstructures form groove shapes and are periodically formed at a pitch of 300 nm to 1.6 μm.

4. The transmitted light control device according to claim 1,
wherein at least one or more additional layers made by depositing a conducting polymer of a different kind from the conducting polymer are formed on said conducting polymer layer.

5. The transmitted light control device according to claim 1,
wherein the conducting polymer includes at least one of polyaniline and poly(3,4-ethylenedioxythiophene).

6. The transmitted light control device according to claim 5,
wherein said conducting polymer layer has a thickness of 10 nm to 40 nm.

7. (canceled)
